(19) United States
(12) Patent Application Publication
(10) Pub. No.: US 2013/0097337 A1
(43) Pub. Date: Apr. 18, 2013

(54) Installation Method of Network Electronic Device and Network Electronic Device Installation Setting System

(71) Applicant: Huang-Jen Chien, New Taipei City (TW)

(72) Inventor: Huang-Jen Chien, New Taipei City (TW)

(73) Assignee: AV TECH CORPORATION, New Taipei City (TW)

(21) Appl. No.: 13/456,953

(22) Filed: Apr. 26, 2012

(30) Foreign Application Priority Data
Oct. 18, 2011 (TW) 100137657

(51) Int. Cl. G06F 15/16

(52) U.S. Cl. 709/250

(57) ABSTRACT

An installation method of a network electronic device and a network electronic device installation setting system, comprising the following steps: transmitting a broadcasting signal with an installation setting module to search network electronic device on LAN; receiving a response signal fed back by the network electronic device by the installation setting module; listing a search result of the network electronic device by the installation setting module; transmitting an apply request to the network electronic device to be installed through the installation setting module when a system user selects one of the at least one network electronic device to be installed; and transmitting a connecting signal to an access point according to the apply request by the network electronic device to configure the access point to open a network connection port to connect the network electronic device to be installed to the Internet.

### CROSS-REFERENCE TO RELATED APPLICATION

This application claims the benefit of Taiwan Patent Application No. 100137657, filed on Oct. 18, 2011, in the Taiwan Intellectual Property Office, the disclosure of which is incorporated herein in its entirety by reference.

### BACKGROUND OF THE INVENTION

1. Field of the Invention

The present invention relates to an installation method of a network electronic device and a network electronic device installation setting system, in particular to an installation method of a network electronic device and a network electronic device installation setting system capable of conveniently and quickly installing the network electronic device having the display function to the Internet without the need to manually input any network setting parameters by the users.

2. Description of the Related Art

As wireless network advanced, webcams are used more extensively in office, nursery school, and our daily lives. With the webcams, a real-time videoconference can be held, parents can perform various image pickup operations, such as watching the activities of their child or monitoring the household security of their home, etc. For providing a user at a third site to perform the real-time image pickup operation through a wireless webcam, the wireless webcam needs to be connected to the Internet or the local area network (LAN) via an access point, such as a router. In the system architecture, the wireless webcam need to be connected to the access point through Ethernet, and then the access point is coupled to a personal computer. Therefore, when the user installs the wireless webcam for the first time, the personal computer has to be connected to the corresponding access point first, and then the user can use the personal computer to enter the configuration webpage of the access point to obtain related network parameters, such as the settings of the service set identifier (SSID).The user also can obtain the setting of data encryption method, such as wired equivalent privacy (WEP) or Wi-Fi protected access (WPA), or parameters of the access point, such as the sub-net mask, domain name sever (NDS) or gateway, etc. When the personal computer is connected to the wireless webcam, the user can fill the network parameter of the access point into an installation configuration webpage of the wireless webcam.

In short, since the user installs the webcam for the first time and the webcam has no the display function, the network connection setup cannot be performed through the webcam. Thus, it is necessary to is required for set the environment parameters of the webcam through an external computer, such as the settings of the network configuration. In addition, the user has to enable the connection port transmission function of the access point to convert the webcam installed at a private IP address into a public IP address, so as to connect the webcam to the Internet. However, the settings of the network configuration tend to be influenced by difficulties of obtaining network parameter, such as private IP addresses or public IP addresses, which significantly increases the difficulty of installing the webcam and reduces the user's willingness of using the webcam.

### SUMMARY OF THE INVENTION

In view of the aforementioned problem of the prior art, it is a primary objective of the present invention to provide an installation method of a network electronic device and a network electronic device installation setting system to overcome the difficult installation that requires an external computer to assist the installation and requires the user to enter the setting parameters when the network electronic device without a display function (such as a webcam or IPcam) is installed.

To achieve the aforementioned objectives, the present invention provides an installation method of a network electronic device, comprising the steps of: transmitting a broadcasting signal with an installation setting module to search at least one network electronic device on LAN; receiving a response signal fed back by the at least one network electronic device by the installation setting module; listing a search result of the at least one network electronic device by the installation setting module; transmitting an apply request to the network electronic device to be installed through the installation setting module when a system user selects one of the at least one network electronic device to be installed; and transmitting a connecting signal to an access point according to the apply request by the network electronic device to configure the access point to open a network connection port to connect the network electronic device to be installed to the Internet.

Preferably, the installation method of a network electronic device of the present invention further comprises the step of installing the installation setting module in a terminal device.

Preferably, the installation method of a network electronic device of the present invention further comprises the step of editing device data of the network electronic device to be installed by the system user through the installation setting module, when the system user selects one of the at least one network electronic device.

Preferably, the installation method of a network electronic device of the present invention further comprises the step of uploading the device data to a remote server database by the installation setting module.

Preferably, the installation method of a network electronic device of the present invention further comprises the step of configuring the network electronic device to transmit the connecting signal to the access point through a universal plug-and-play protocol to automatically perform a connection setup in order to connect the network electronic device to the Internet through the network connection port.

Preferably, the installation method of a network electronic device of the present invention further comprises the steps of recording connection data by the network electronic device, and transmitting the connection data to a remote server database, after the network electronic device is connected to the Internet.

In addition, the present invention also provides a network electronic device installation setting system, comprising a network electronic device, an access point and a terminal device. The network electronic device is provided for receiving a broadcasting signal, and outputting a response signal according to the broadcasting signal. The access point comprises a plurality of network connection ports, one of the pluralities of network connection ports being coupled to the network electronic device. The terminal device comprises an installation setting module provided for outputting broadcasting signal, and the terminal device searching the network electronic device and then recognizing the network electronic device according to the response signal. Wherein, when the terminal device is provided for a system user to install the network electronic device, the terminal device transmits an apply request to the network electronic device, and the network electronic device transmits a connection signal to the access point according to the apply request to request the access point to open the network connection port coupled to the network electronic device to establish a network channel, so as to connect the network electronic device to the Internet through the network connection port.

Wherein, the response signal includes a media access control address, a physical address or a device ID code.

In summary, the installation method of a network electronic device and the network electronic device installation setting system in accordance with the present invention have one or more of the following advantages:

(1) The installation method of a network electronic device and the network electronic device installation setting system can install the installation setting module to a handheld electronic device such as a computer or a mobile phone, and the handheld device allows a user to install a network electronic device without a display function (such as a webcam or IPcam) to a network easily. The user does not require entering the setting parameters of the network to complete the installation, so as to achieve an easy and simple installation of the network electronic device without a display function.

(2) The installation method of a network electronic device and the network electronic device installation setting system can use a remote server database to record device data of a webcam (or a IPcam) or connection data of a network electronic device without a display function, so as to overcome the problems that the webcam (or the IPcam) needs to be reinstalled and the network connection port needs to be reconfirmed or reset because of a fail connection after the webcam (or the IPcam) is installed.

### BRIEF DESCRIPTION OF THE DRAWINGS

FIG. 1 is a flow chart of an installation method of a network electronic device in accordance with the present invention;

FIG. 2 is a first schematic view of a network electronic device installation setting system in accordance with a preferred embodiment of the present invention; and

FIG. 3 is a second schematic view of a network electronic device installation setting system in accordance with a preferred embodiment of the present invention.

### DETAILED DESCRIPTION OF THE PREFERRED EMBODIMENTS

The technical characteristics of the present invention will become clear with the detailed description of the preferred embodiments accompanied with the illustration of related drawings as follows. It is noteworthy to point out that same numerals are used for representing respective elements for the description of the preferred embodiments and the illustration of the drawings.

The installation method of a network electronic device in accordance with the present invention primarily uses a simple handheld electronic device to install and connect a network electronic device without a display function to a network. There are various types of network electronic devices without a display function, and they will not be listed one by one, and the webcam or IPcam is used as an example of the network electronic device in the following preferred embodiments to illustrate the present invention. However, the scope of the invention is not limited to webcams or IPcam only.

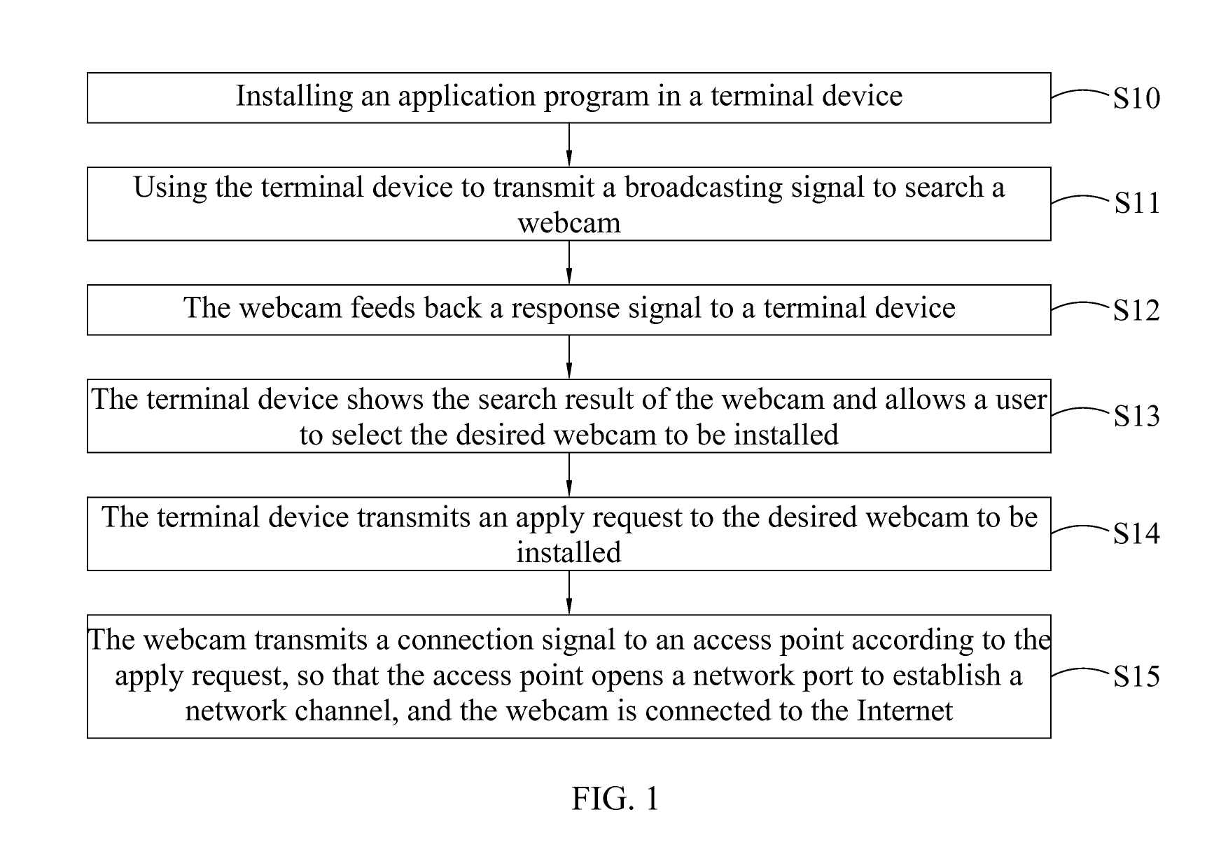

With reference to FIG. 1 for a flow chart of an installation method of a network electronic device in accordance with the present invention, the webcam is used as a preferred embodiment for illustrating the network electronic device. The present invention relates to a method of installing a webcam to a wireless or cable network to facilitate users to use a terminal device, such as a mobile apparatus or a handheld electronic product for the installation of the webcam. The installation method of the webcam system comprises the following steps:

S10: A user installs an application program in a terminal device, wherein the application program refers to the installation setting module of the present invention. The terminal device includes a mobile apparatus, such as a smart phone, a tablet computer, an iPhone or an iPad.

S11: After the application program is installed, the user can use the terminal device to transmit a broadcasting signal through the application program to search a network electronic device in a local area network (LAN). The network electronic device can be a webcam, a mobile phone, a notebook, or any device having a transmission device capable of communicating with other devices through the transmission control protocol/Internet protocol (TCP/IP) or other communication protocol. A webcam is adopted in this embodiment.

S12: After the webcam of the LAN receives the broadcasting signal, the webcam feeds back a response signal to a terminal device which transmits the broadcasting signal. The response signal includes a media access control address (MAC Address), a physical address or an identity code (ID), so that the terminal device receiving this response signal can identify the device type, device model, device address or device location of the webcam according to the response signal.

S13: The application program can obtain the network address of each webcam according to the adjacent media access control addresses, physical addresses or other ID codes of the webcam, and the application program can show the adjacent webcams on a list of the search result according to the network addresses. The list of the search result is provided for the user to select a desired webcam to be installed. After the user has selected the desired webcam to be installed, the user can further confirm or edit the device data of the webcam through the application program. For example, the user can redefine the data including the device name, the device location, the device model or the network connection port.

S14: After the user confirms or corrects the device data, the user can press an apply button in the application program, so that the terminal device transmits an apply request including the device data to the corresponding webcam. In the meantime, the application program also uploads the device data to a remote server such as a dynamic domain name service server (DDNS Server) to update and record the device data of the webcam immediately.

S15: The webcam can transmit a connection signal to an access point according to the apply request and conducting a communication to perform a network connection setup automatically via a universal plug-and-play (UPnP) protocol and an access point, such as a router, so that the access point opens a corresponding network connection port to establish a network channel, and the webcam is connected to the Internet to complete the installation procedure of the webcam. For example, when a user wants to install the IPcam via a handheld electronic device in accordance with the present invention, the user can set the handheld electronic device to transmit a request signal to the IPcam asking for enabling the UPnP port forwarding function. Thereby, a router with network address translation (NAT) function will allow the IPcam to have a port enabled to connect to the Internet. After that, the IPcam will transmit a port number to the handheld electronic device while the above setting is completed. At the last, the handheld electronic device can connect to the IPcam via the Internet according to the port number.

In the meantime, the webcam can record the connection data about this operation into an address account of a remote server. The webcam can update the address and the network connection port to the address account periodically to reduce the error rate of the webcam that requires re-installation, re-conformation, and resetting due to a network disconnection.

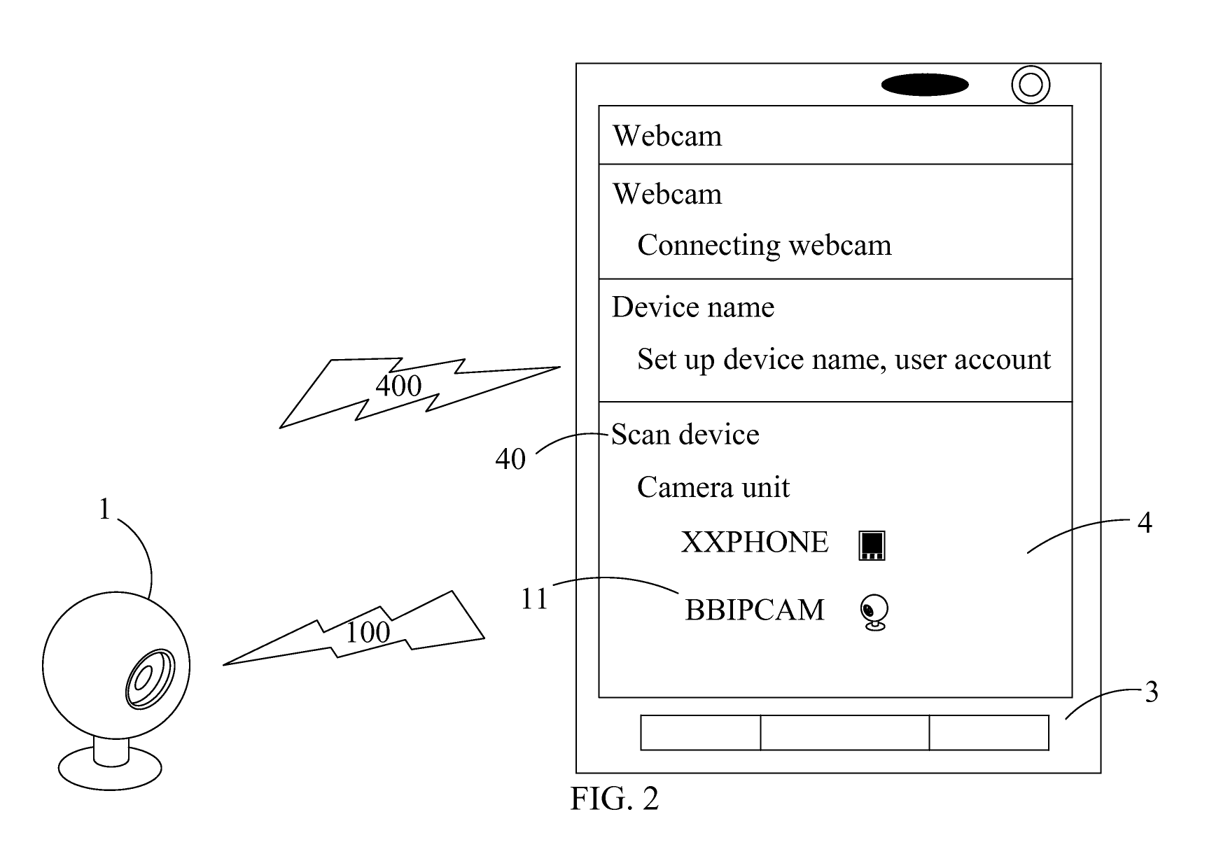

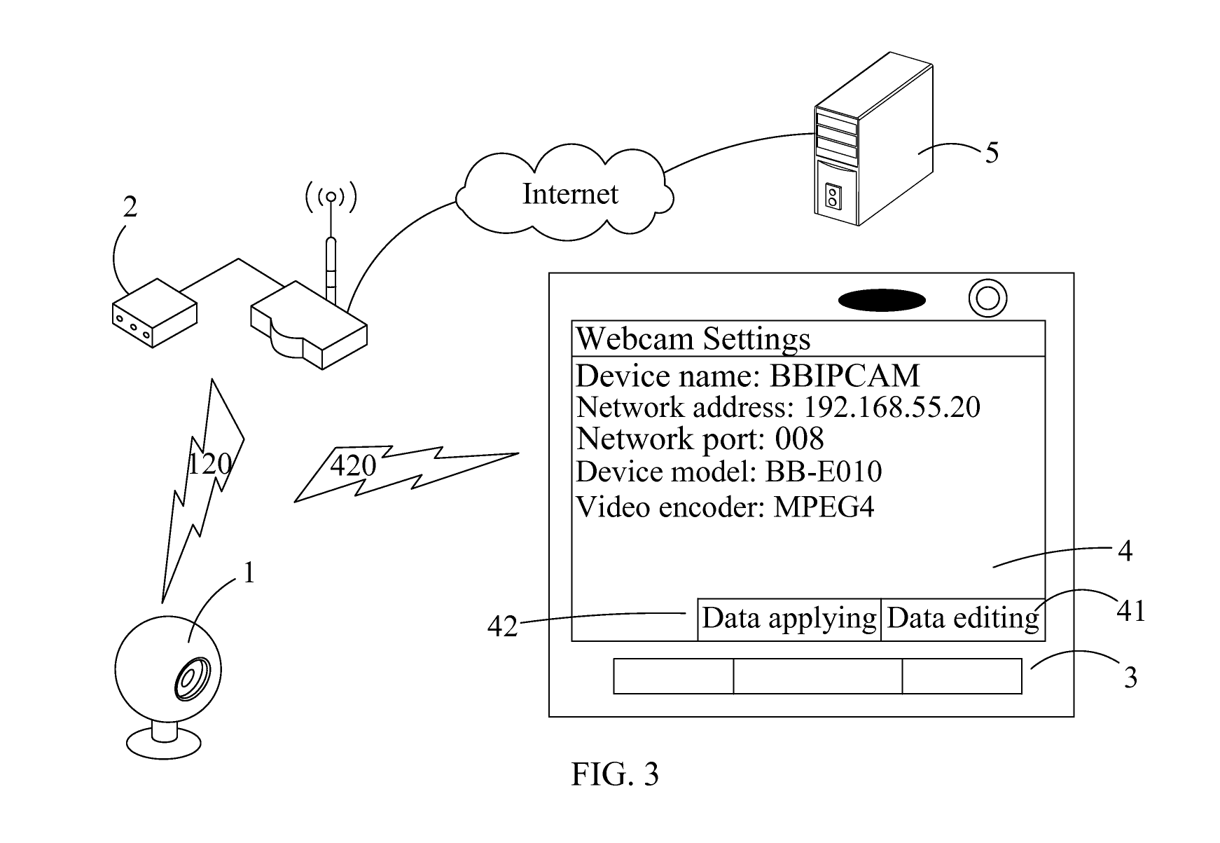

With reference to FIGS. 2 and 3 for first and second schematic views of a network electronic device installation setting system in accordance with a preferred embodiment of the present invention respectively, the network electronic device installation setting system comprises a network electronic device which is a webcam 1 in this preferred embodiment, an access point 2 and a terminal device 3, wherein the terminal device 3 can be a mobile apparatus such as a smart phone, a tablet computer, an iPhone or an iPad. The user can install an application program 4 in the terminal device 3 first. After the application program 4 is installed, the user can enter into an initialization screen, and a scan device control key 40 in the application program 4 is used to send a broadcasting signal 400 from the terminal device 3 to search the remaining network device in the LAN. The network device can be a webcam, a mobile phone, a notebook computer, or any other device capable of communicating with each other through the TCP/IP protocol or any other communication protocol.

After the webcam 1 in the LAN receives the broadcasting signal 400, the webcam 1 can feed back a response signal 100 to the terminal device 3, so that the terminal device 3 shows the search result in the application program 4. In addition, the response signal 100 includes a media access control address, a physical address or an ID code, so that the terminal device 3 can identify information including the device type, the device model, the device address and the device location of the webcam 1 according to the response signal 100.

After the user selects the desired webcam 11 to be installed from the list of the search result, the application program 4 can switch to a setup screen to allow the user to confirm the device data of the desired webcam 11 to be installed, or the user can press a data editing button 41 to edit the device data through the application program 4, or redefine data of the device name, device model or network connection port of the webcam 11. After the user confirms or corrects the device data, the user can press a data applying button 42, so that the terminal device 3 transmits an apply request 420 including the device data to the corresponding webcam 1. In the meantime, the terminal device 3 can upload the device data to a remote server 5 such as a DDNS server to update and record the device data of the webcam immediately.

The webcam 1 transmits a connection signal 120 to the access point 2 according to the apply request 420, and sets a connection setting automatically through a universal plug-and-play protocol, so that the access point 2 opens a corresponding network connection port to establish a network channel, and the webcam 1 connects to the Internet to complete the installation procedure of the webcam 1. In the meantime, the webcam 1 can record the connection data of current time into the address account of the remote server 5, and the webcam 1 can update the address and the corresponding network connection port to the address account periodically to reduce the error percentage of the webcam that requires re-installation, re-conformation, and resetting due to a network disconnection.

In summation of the description above, the installation method of a network electronic device and the network electronic device installation setting system in accordance with the present invention install a camera application program and users enter network setting parameters through a present existing communication protocol to install a network electronic device without a display function such as the webcam, so as to achieve an easy and simple installation of the webcam. A remote server database is provided for recording device data or connection data of the webcam, so as to overcome the problems of installing, confirming or setting the network connection port again caused by a network disconnection after the webcam is installed.

While the invention has been described by means of specific embodiments, numerous modifications and variations could be made thereto by those skilled in the art without departing from the scope and spirit of the invention set forth in the claims.

What is claimed is:

1. An installation method of a network electronic device, comprising:
transmitting a broadcasting signal by an installation setting module to search at least one network electronic device on a local area network;
receiving a response signal fed back by the at least one network electronic device by the installation setting module;
listing a search result of the at least one network electronic device by the installation setting module;
transmitting an apply request to the network electronic device to be installed through the installation setting module when a system user selects one of the at least one network electronic device to be installed; and
transmitting a connecting signal to an access point according to the apply request by the network electronic device to configure the access point to open a network connection port in order to connect the network electronic device to be installed to the Internet.

2. The installation method of a network electronic device as recited in claim 1, further comprising the following step of:
installing the installation setting module in a terminal device.

3. The installation method of a network electronic device as recited in claim 1, further comprising the following step of:
editing device data of the network electronic device to be installed by the system user through the installation setting module, when the system user selects one of the at least one network electronic device.

4. The installation method of a network electronic device as recited in claim 3, further comprising the following step of:
uploading the device data to a remote server database by the installation setting module.

5. The installation method of a network electronic device as recited in claim 1, further comprising the following step of:
configuring the network electronic device to transmit the connecting signal to the access point through a universal plug-and-play protocol to automatically perform a connection setup in order to connect the network electronic device to the Internet through the network connection port.

6. The installation method of a network electronic device as recited in claim 1, further comprising the following step of:
recording connection data by the network electronic device, and transmitting the connection data to a remote server database, after the network electronic device is connected to the Internet.

7. The installation method of a network electronic device as recited in claim 1, wherein the response signal further includes a media access control address, a physical address or a device identification code.

8. A network electronic device installation setting system, comprising:
a network electronic device, for receiving a broadcasting signal, and outputting a response signal according to the broadcasting signal;
an access point, comprising a plurality of network connection ports, one of the plurality of network connection ports being coupled to the network electronic device; and
a terminal device, comprising an installation setting module provided for outputting broadcasting signal, and the terminal device searching the network electronic device and then recognizing the network electronic device according to the response signal;
wherein, when the terminal device is provided for a system user to install the network electronic device, the terminal device transmits an apply request to the network electronic device, and the network electronic device transmits a connecting signal to the access point according to the apply request to request the access point to open the network connection port coupled to the network electronic device to establish a network channel, so as to connect the network electronic device to the Internet through the network connection port.

9. The network electronic device installation setting system of claim 8, wherein when the terminal device searches the network electronic device and then recognize the network electronic device according to the response signal, the installation setting module is provided for the system user to edit device data of the network electronic device.

10. The network electronic device installation setting system of claim 9, wherein the terminal device uploads the device data to a remote server database.

11. The network electronic device installation setting system of claim 8, further comprising a universal plug-and-play protocol provided for configuring the network electronic device and the access point to perform a connection setup automatically, so as to connect the network electronic device to the Internet through the network connection port.

12. The network electronic device installation setting system of claim 8, wherein when the network electronic device is connected to the Internet, the network electronic device records connection data and transmits the connection data to a remote server database.

13. The network electronic device installation setting system of claim 8, wherein the response signal further includes a media access control address, a physical address or a device identification code.
